(19) United States
(12) Patent Application Publication
(10) Pub. No.: US 2024/0312154 A1
(43) Pub. Date: Sep. 19, 2024

(54) AUTHORING EDGE-BASED OPPORTUNISTIC TANGIBLE USER INTERFACES IN AUGMENTED REALITY

(71) Applicant: Purdue Research Foundation, West Lafayette, IN (US)

(72) Inventors: Karthik Ramani, West Lafayette, IN (US); Fengming He, West Lafayette, IN (US); Xun Qian, West Lafayette, IN (US); Jingyu Shi, West Lafayette, IN (US); Xiyun Hu, West Lafayette, IN (US)

(21) Appl. No.: 18/584,258

(22) Filed: Feb. 22, 2024

Related U.S. Application Data
(60) Provisional application No. 63/490,316, filed on Mar. 15, 2023.

(51) Int. Cl. G06T 19/00; G06T 13/20; G06T 19/20; G06V 40/20

(52) U.S. Cl. CPC G06T 19/006; G06T 13/20; G06T 19/20; G06V 40/28; G06T 2219/2004; G06T 2219/2012; G06T 2219/2016; G06T 2219/2021; G06V 2201/07

(57) ABSTRACT

An Tangible User Interface (TUI) authoring system is disclosed that allows end-users to customize edges on daily objects as TUI inputs to control varied digital functions. The TUI application authoring system incorporates an integrated AR-device and an integrated vision-based detection pipeline that can track 3D edges and detect the touch interaction between fingers and edges. Leveraging the spatial-awareness of AR, users can simply select an edge by sliding fingers along it and then make the edge interactive by connecting it to various digital functions. The system is demonstrated using four exemplary use cases including multi-function controllers, smart homes, games, and TUI-based tutorials.

This application claims the benefit of priority of U.S. provisional application Ser. No. 63/490,316, filed on Mar. 15, 2023 the disclosure of which is herein incorporated by reference in its entirety.

### GOVERNMENT LICENSE RIGHTS

This invention was made with government support under contract number DUE1839971 awarded by the National Science Foundation. The government has certain rights in the invention.

### FIELD

The device and method disclosed in this document relates to augmented reality and, more particularly, to authoring edge-based tangible user interfaces in augmented reality.

### BACKGROUND

Unless otherwise indicated herein, the materials described in this section are not admitted to be the prior art by inclusion in this section.

Tangible User Interfaces (TUIs) have become one of the essential ways of rendering haptic feedback in Augmented Reality (AR). End-users can pervasively execute digital services by physically interacting with surrounding objects. Further, opportunistic TUIs, which tightly map the affordance of physical objects (e.g., corner, cylinder, and surface) with the functions of the virtual widgets (e.g., buttons, knobs, and touch pads), provide a more intuitive connection between the user inputs and digital services. However, such strict mappings limit the generalizability of opportunistic TUIs. Particularly, it is hard for end users to find an everyday object that perfectly matches the target digital functions both geometrically and semantically.

Traditional predefined TUIs require predesignated pairs of tangible interfaces and digital functions. Therefore, the versatility of TUIs is limited, and it is hard to adapt the predefined TUIs to any user or task that is beyond the original design. To address this issue, the concept of end-user authoring has been proposed to equip end-users with customization tools so that users can follow their preferences and build interactions based on their local context. Multiple prior works have demonstrated such a possibility by leveraging in-situ AR/VR visualization, embodied interactions and programming by demonstration techniques. However, a system and workflow for building pervasive and customized tangible AR interfaces still remains to be explored.

### SUMMARY

A method for authoring an application incorporating a tangible user interface is disclosed. The method comprises defining, with a processor, an interactable edge of a physical object in an environment based on a physical interaction of a user with the physical object. The method further comprises associating, with the processor, based on user inputs received from the user, the interactable edge of the physical object with an action to be performed in response to the user touching the interactable edge of the physical object. The method further comprises causing, with the processor, the action to be performed in response to detecting the user touching the interactable edge of the physical object.

### BRIEF DESCRIPTION OF THE DRAWINGS

The foregoing aspects and other features of the system and method are explained in the following description, taken in connection with the accompanying drawings.

FIGS. 1A-1B summarize a workflow for authoring edge-based opportunistic TUIs using a TUI authoring system.

FIG. 2 shows exemplary components of an augmented reality (AR) system of the TUI authoring system.

FIG. 3 summarizes the input-output model adopted by the TUI authoring system.

FIG. 4 shows a logical flow diagram for a method for authoring AR applications having TUI interactions.

FIG. 5 shows interface elements of various AR graphical user interfaces of the TUI authoring system.

FIG. 6 illustrates an edge detection process of the TUI authoring system.

FIG. 7 shows a first exemplary TUI application in which an object is repurposed into a multi-functional controller.

FIG. 8 shows a second exemplary TUI application in which ubiquitous control is enabled over physical smart objects.

FIG. 9 shows a third exemplary TUI application in which an interactive tangible AR game is authored.

FIG. 10 shows a fourth exemplary TUI application in which a ubiquitous tangible AR tutorial is authored.

### DETAILED DESCRIPTION

For the purposes of promoting an understanding of the principles of the disclosure, reference will now be made to the embodiments illustrated in the drawings and described in the following written specification. It is understood that no limitation to the scope of the disclosure is thereby intended. It is further understood that the present disclosure includes any alterations and modifications to the illustrated embodiments and includes further applications of the principles of the disclosure as would normally occur to one skilled in the art which this disclosure pertains.

### Overview

A Tangible User Interface (TUI) authoring system 100 is introduced herein, which enables end-users to author object edge-based TUIs using an intuitive AR graphical user interface. Edges are one of the most ubiquitous geometric features of physical objects. They provide accurate haptic feedback and easy-to-track features for camera systems, making them an ideal basis for TUIs that are integrated with AR systems. The TUI authoring system 100 aims to allow end-users to easily create personalized edge-based TUIs in their own environment. In this way, users can interact with them in daily life. The TUI authoring system 100 utilizes an AR head-mounted device (AR-HMD) 123 with an RBG camera and LIDAR sensor integrated thereon to enable pervasive and accurate detection of all available edges on physical objects via an edge detection algorithm.

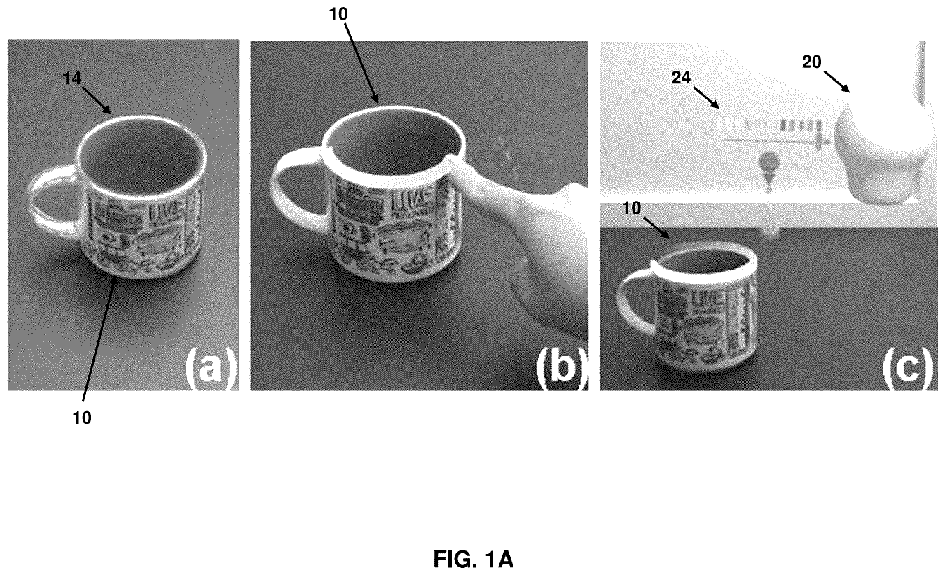

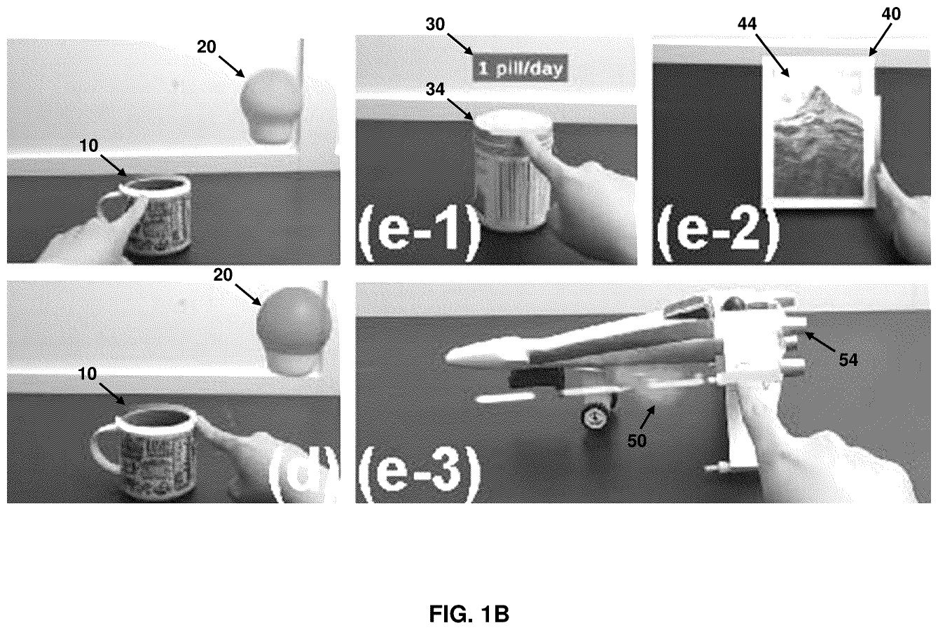

FIGS. 1A-1B summarize a workflow for authoring edge-based opportunistic TUIs using the TUI authoring system 100. The workflow is described with respect to an example in which a user authors an AR application that utilizes a rim of a coffee cup 10 as a TUI to control a color of a virtual light bulb 20 displayed in an AR graphical user interface. First, a user scans a coffee cup 10 located in the user's immediate environment using the AR-HMD 123 to detect and register geometric edges of the coffee cup 10 into the TUI authoring system 100. Particularly, the user moves to a position where the coffee cup 10's rim is visible and, at the same time, the AR-HMD 123 captures RGB-D information of the coffee cup 10 to detect geometric edge points on the coffee cup 10. As shown in illustration (a) of FIG. 1A, once the edges of the coffee cup 10 are registered, a visualization of the edges, such as edge points 14, are overlaid upon the real edges of the coffee cup 10 in an AR graphical user interface of the AR-HMD 123.

Next, with the support of the TUI authoring system 100, the user can use touch to define an edge of a physical object to be used as a TUI. To define an interactable edge for a TUI, the user slides a finger along the desired edge to define an edge segment. As shown in illustration (b) of FIG. 1A, the end-user slides his or her finger along the top rim of the coffee cup 10 to define an interactable segment of the rim as the TUI input. The TUI authoring system 100 determines the starting and ending point of the interactable edge by detecting the touch interaction with the desired edge. After defining the interactable edge, the user sets an interactable edge type for the selected edge to be continuous, which means that the tangible input will be treated as a continuous value between 0 to 1.

Next, following a trigger-action programming metaphor, the user associates the interactable edge with an action to define a TUI. The action may comprise a variety of digital functions in the AR graphical user interface (e.g., interactive virtual objects or applications in AR) or physical operations of controllable physical devices (e.g., IoT devices). As shown in illustration (c) of FIG. 1A, the user specifies the available color range 24 of the virtual light bulb 20, and associates the interactable edge of the coffee cup 10 with a color change action via spatial programming in the AR graphical user interface. In this way, the user has authored a TUI application in which the user can touch the rim of the coffee cup 10 to change the color of the virtual light bulb 20 to various different colors corresponding to the different touch locations on the rim of the coffee cup 10.

Finally, the user can experience the authored TUI application. During run-time usage, the TUI authoring system 100 detects when the user touches an interactable edge in the environment and, in the case of continuous type interactable edges, the TUI authoring system 100 tracks the finger's relative position on the interactable edge. As shown in illustration (d) of FIG. 1B, in the physical world, the user uses the finger to slide on the rim of the coffee cup 10 to gradually change the color of the virtual light bulb 20.

It should be appreciated that controlling the color of a virtual light bulb 20 using the rim of a coffee cup 10 is but only one of countless possibilities for TUI applications that might be authored using the TUI authoring system 100. With continued reference to FIG. 1B, three more exemplary TUI applications authored using the TUI authoring system 100 are shown. In illustration (e-1) of FIG. 1B, an example TUI application is shown in which an AR medication reminder 30 appears after the user touches the edge of a cap of pill bottle 34. In illustration (e-2) of FIG. 1B, an example TUI application is shown in which a digital photo frame 40 displays a new photo 44 after the user slides his or her finger down on the right side of the photo frame 40. In illustration (e-3) of FIG. 1B, an example TUI application is shown in which a virtual weapon shooting animation 50 starts to play next to a toy aircraft 54 after the user clicks an edge on a wing of toy aircraft 54.

In summary, the TUI authoring system 100 provides an end-to-end authoring workflow that allows end-users to author edge-based TUIs that execute digital functions when the users interact with customized segments of physical edges on everyday objects. The TUI authoring system 100 provides several advantages over conventional systems.

The TUI authoring system 100 advantageously leverages local geometric features, instead of the entire object for the purpose of authoring TUIs. Specifically, the TUI authoring system 100 provides authoring features that focus on edges and sides, especially the linear and circular ones, that exist ubiquitously on nearly every object such as tables, books, mugs, and monitors. Edges provide sharp tactile feedback that even allows users to provide accurate inputs without careful attention. Meanwhile, the affordances involved in assorted types of edges, i.e., short edges and corners (intersections of edges) as buttons, linear edges as sliders, and circular edges as knobs, can fulfill diverse user needs to control different virtual contents and controllable physical devices. Additionally, edges provide strong geometric features for computer vision algorithms, which allows for instant, marker-free and non-intrusive tracking compared with marker-based systems.

Additionally, the TUI authoring system 100 provides a flexible and immersive AR authoring interface that enables end-users to segment edges through in-situ interactions while referring to the physical object, and define the corresponding digital functions through visual programming. By leveraging the advantages of immersive experiences and affordances of spatial awareness provided by AR, the TUI authoring system 100 enables in-situ digital content manipulation, visualized embodied demonstration, and effortless trigger-action programming. Particularly, to enable end-users to understand which edges can be authored and to help users to effectively program their own TUIs, the TUI authoring system 100 provides real-time visual feedback about interactable edges and corresponding authoring results. Additionally, to let the users customize an edge-based interaction as they wish, the TUI authoring system 100 includes a variety of choices for digital functions and a straight-forward AR spatial programming interface. In this way, users can easily pair interactive edges with any possible digital function and edit the function parameters.

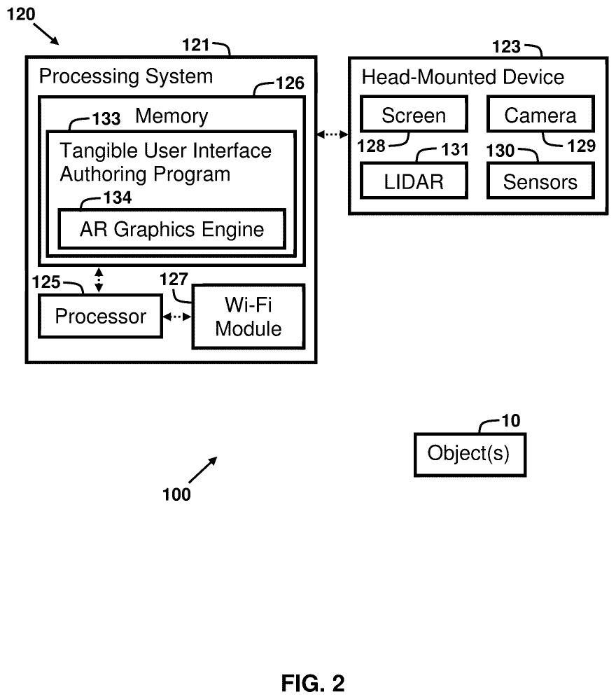

FIG. 2 shows exemplary components of an AR system 120 of the TUI authoring system 100. It should be appreciated that the components of the AR system 120 shown and described are merely exemplary and that the AR system 120 may comprise any alternative configuration. Moreover, in the illustration of FIG. 2, only a single AR system 120 is shown. However, in practice the TUI authoring system 100 may include one or multiple AR systems 120.

To enable the AR authoring environment, the TUI authoring system 100 at least includes the AR system 120, at least part of which is worn or held by a user, and one or more objects 10 in the environment that are scanned or interacted with by the user. The AR system 120 preferably includes the AR-HMD 123 having at least a camera and a display screen, but may include any mobile AR device, such as, but not limited to, a smartphone, a tablet computer, a handheld camera, or the like having a display screen and a camera. In one example, the AR-HMD 123 is in the form of an AR or virtual reality headset (e.g., Microsoft's HoloLens, Oculus Rift, or Oculus Quest) or equivalent AR glasses having an integrated or attached front-facing stereo-camera 129.

In the illustrated exemplary embodiment, the AR system 120 includes a processing system 121, the AR-HMD 123, and (optionally) external sensors (not shown). In some embodiments, the processing system 121 may comprise a discrete computer that is configured to communicate with the AR-HMD 123 via one or more wired or wireless connections. In some embodiments, the processing system 121 takes the form of a backpack computer connected to the AR-HMD 123. However, in alternative embodiments, the processing system 121 is integrated with the AR-HMD 123. Moreover, the processing system 121 may incorporate server-side cloud processing systems.

As shown in FIG. 2, the processing system 121 comprises a processor 125 and a memory 126. The memory 126 is configured to store data and program instructions that, when executed by the processor 125, enable the AR system 120 to perform various operations described herein. The memory 126 may be of any type of device capable of storing information accessible by the processor 125, such as a memory card, ROM, RAM, hard drives, discs, flash memory, or any of various other computer-readable media serving as data storage devices, as will be recognized by those of ordinary skill in the art. Additionally, it will be recognized by those of ordinary skill in the art that a “processor” includes any hardware system, hardware mechanism or hardware component that processes data, signals or other information. The processor 125 may include a system with a central processing unit, graphics processing units, multiple processing units, dedicated circuitry for achieving functionality, programmable logic, or other processing systems.

The processing system 121 further comprises one or more transceivers, modems, or other communication devices configured to enable communications with various other devices. Particularly, in the illustrated embodiment, the processing system 121 comprises a Wi-Fi module 127. The Wi-Fi module 127 is configured to enable communication with a Wi-Fi network and/or Wi-Fi router (not shown) and includes at least one transceiver with a corresponding antenna, as well as any processors, memories, oscillators, or other hardware conventionally included in a Wi-Fi module. As discussed in further detail below, the processor 125 is configured to operate the Wi-Fi module 127 to send and receive messages, such as control and data messages, to and from other devices via the Wi-Fi network and/or Wi-Fi router. It will be appreciated, however, that other communication technologies, such as Bluetooth, Z-Wave, Zigbee, or any other radio frequency-based communication technology can be used to enable data communications between devices in the system 100.

In the illustrated exemplary embodiment, the AR-HMD 123 comprises a display screen 128 and the camera 129. The camera 129 is configured to capture a plurality of images of the environment as the AR-HMD 123 is moved through the environment by the user. The camera 129 is configured to generate image frames of the environment, each of which comprises a two-dimensional array of pixels. Each pixel at least has corresponding photometric information (intensity, color, and/or brightness). In some embodiments, the camera 129 operates to generate RGB-D images in which each pixel has corresponding photometric information and geometric information (depth and/or distance). In such embodiments, the camera 129 may, for example, take the form of an RGB camera 129 that operates in association with a LIDAR sensor, in particular a LIDAR camera 131, configured to provide both photometric information and geometric information. The LIDAR camera 131 may be separate from or directly integrated with the RGB camera 129. In an indoor setting, the LIDAR camera 131 is designed to, for example, capture depth from 0.25 m to 9 m, with reflectivity affecting the depth. Alternatively, or in addition, the camera 129 may comprise two RGB cameras 129 configured to capture stereoscopic images, from which depth and/or distance information can be derived. In one embodiment, the resolution is 1280×720 for the RGB color image and the resolution is 1024×768 for the depth image. In one embodiment, the color and depth image frames are aligned with a same frame rate of 30 fps.

In some embodiments, the AR-HMD 123 may further comprise a variety of sensors 130. In some embodiments, the sensors 130 include sensors configured to measure one or more accelerations and/or rotational rates of the AR-HMD 123. In one embodiment, the sensors 130 include one or more accelerometers configured to measure linear accelerations of the AR-HMD 123 along one or more axes (e.g., roll, pitch, and yaw axes) and/or one or more gyroscopes configured to measure rotational rates of the AR-HMD 123 along one or more axes (e.g., roll, pitch, and yaw axes). In some embodiments, the sensors 130 may further include IR cameras. In some embodiments, the sensors 130 may include inside-out motion tracking sensors configured to track human body motion of the user within the environment, in particular positions and movements of the head, arms, and hands of the user.

The display screen 128 may comprise any of various known types of displays, such as LCD or OLED screens. In at least one embodiment, the display screen 128 is a transparent screen, through which a user can view the outside world, on which certain graphical elements are superimposed onto the user's view of the outside world. In the case of a non-transparent display screen 128, the graphical elements may be superimposed on real-time images/video captured by the camera 129. In further embodiments, the display screen 128 may comprise a touch screen configured to receive touch inputs from a user.

The AR-HMD 123 may also include a battery or other power source (not shown) configured to power the various components within the AR-HMD 123, which may include the processing system 121, as mentioned above. In one embodiment, the battery of the AR-HMD 123 is a rechargeable battery configured to be charged when the AR-HMD 123 is connected to a battery charger configured for use with the AR-HMD 123.

The program instructions stored on the memory 126 include a tangible user interface authoring program 133. As discussed in further detail below, the processor 125 is configured to execute the tangible user interface authoring program 133 to enable the authorship and utilization of TUI AR applications by the user. In one embodiment, the tangible user interface authoring program 133 is implemented with the support of Microsoft Mixed Reality Toolkit (MRTK). In one embodiment, the tangible user interface authoring program 133 includes an AR graphics engine 134 (e.g., Unity3D engine), which provides an intuitive visual interface for the tangible user interface authoring program 133. Particularly, the processor 125 is configured to execute the AR graphics engine 134 to superimpose on the display screen 128 graphical elements for the purpose of authoring TUI AR applications, as well as providing graphics and information as a part of utilizing of the TUI AR applications. In the case of a non-transparent display screen 128, the graphical elements may be superimposed on real-time images/video captured by the camera 129.

### Input-Output Model for Authoring Edge-Based Tangible User Interfaces

Before describing the methods for authoring applications incorporating edge-based TUIs, the input-output model adopted by the TUI authoring system 100 is first described.

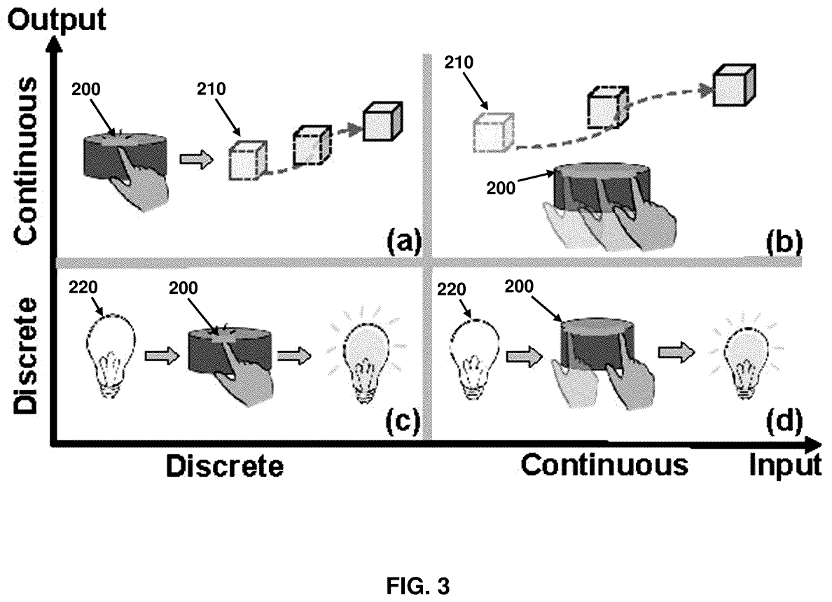

FIG. 3 summarizes the input-output model adopted by the TUI authoring system 100. Particularly, the TUI authoring system 100 provides a programming tool that adopts the input-output model as the programming modality. The input-output model has been widely used in authoring systems to assist end-users in efficient customization. Within the input-output model, an input is initiated by a subject and an output is generated in response to the input. As used herein, the input of a TUI interaction refers to a touch interaction with a tangible edge of a physical object and an output of a TUI interaction refers to an action or behavior of relevant virtual content or a controllable physical device.

The input-output model of the TUI authoring system 100 summarizes the possible types of inputs into the following categories: (1) discrete inputs, which indicate whether or not a touch interaction has taken place (e.g., a binary value 0 or 1) with respect to a particular interactable edge and (2) continuous inputs, which not only indicate whether or not a touch interaction has taken place with respect to a particular interactable edge, but also indicate a current state of the touch interaction as a continuous value over time (e.g., a continuous value between 0 to 1) during a touch interaction, such as touch positions over time, touch manipulation path lengths over time, and finger moving directions over time.

Additionally, the input-output model of the TUI authoring system 100 summarizes the possible types of outputs into the following categories: (1) discrete outputs, which indicate a state change of relevant virtual content or a controllable physical device after the touch interaction and (2) continuous outputs, which represent a series of state changes over time of relevant virtual content or a controllable physical device after the touch interaction.

Finally, the TUI authoring system 100 adopts a trigger-action programming metaphor. Specifically, users can connect a trigger (i.e., a discrete or continuous input) with a target action (i.e., a discrete or continuous output) and create combinations of different types of inputs with outputs to author various TUI interactions. With the support of the trigger-action metaphor, users are able to connect one input to multiple outputs so that multiple actions can be activated at the same time. Moreover, users can associate multiple inputs to the same output and either input can activate the output. Each possible combination in the input-output model is discussed below.

A Discrete-Continuous TUI interaction (top-left quadrant of FIG. 3) is one that combines a discrete input-trigger with a continuous output-action. This category represents interactions in which a series of state changes over time of the relevant virtual content or controllable physical device occurs after a touch interaction is detected. A typical exemplary interaction is that an AR animation starts when the user touches an interactable edge. In the illustration (a) of FIG. 3, a Discrete-Continuous TUI interaction is shown in which a user touches an interactable edge 200 and a virtual box 210 is animated to move through the environment over time. Another example was shown in illustration (e-3) of FIG. 1B. In this example, the virtual weapon shooting animation 50 starts to play after the user touches the edge of the wing of the toy aircraft 54.

A Continuous-Continuous TUI interaction (top-right quadrant of FIG. 3) is one that combines a continuous input-trigger with a continuous output-action. This category represents interactions in which the relevant virtual content or controllable physical device responds synchronously to a position of the finger on the interactable edge. An intuitive exemplary interaction is one in which the interactable edge serves as a slider. In the illustration (b) of FIG. 3, a Continuous-Continuous TUI interaction is shown in which a user slides his or her finger along the interactable edge 200 and the virtual box 210 is animated to move through the environment over time depending on a location at which the user touches the interactable edge 200. Another example was shown in illustration (d) of FIG. 1B. In this example, the rim of the coffee cup 10 is repurposed into a controller for changing the light color of the virtual light bulb 20 and the color of the virtual light bulb 20 gradually changes from green to blue when the user moves his or her finger from left to right.

A Discrete-Discrete TUI interaction (bottom-left quadrant of FIG. 3) is one that combines a continuous input-trigger with a discrete output-action. This category represents interactions in which the relevant virtual content or controllable physical device changes state from one to another after a touch interaction with a tangible edge is detected. One common exemplary interaction is one in which an on/off function is triggered when the user touches an interactable edge. In the illustration (c) of FIG. 3, a Discrete-Discrete TUI interaction is shown in which a user touches an interactable edge 200 and a virtual light bulb 220 is shown to turn on. Another example was shown in illustration (e-1) of FIG. 1B. In this example, after the user touches the edge segment of the cap of a pill bottle 34, an AR medication reminder 30 indicating pills to take appears.

A Continuous-Discrete TUI interaction (bottom-right quadrant of FIG. 3) is one that combines a continuous input-trigger with a discrete output-action. This category represents interactions in which the state of the relevant virtual content or controllable physical device adjusts depending on a position of the finger on the interactable edge. In the illustration (d) of FIG. 3, a Continuous-Discrete TUI interaction is shown in which a user slides his or her finger along the interactable edge 200 and the virtual light bulb 220 is shown to turn on with a brightness depending on a location at which the user touches the interactable edge 200. Another example was shown in illustration (e-2) of FIG. 1B. In this example, the digital photo frame 40 changes to the next photo 44 when the user moves the finger from top to bottom of the edge of the digital photo frame 40.

### Methods for Edge-Based Interaction Authoring in Augmented Reality

The TUI authoring system 100 is configured to enable the user to author edge-based TUI applications using an AR-based graphical user interface on the display 128. To this end, the AR system 120 is configured to provide a variety of AR graphical user interfaces and interactions therewith which can be accessed in the following three modes of the AR system 120: Scan Mode, Author Mode, and Play Mode. In the Scan Mode, the AR system 120 enables the user to scan all edges on a physical object. These edges become candidates for authoring edge-based TUI applications. In the Author Mode, the AR system 120 enables a user to design and edit edge-based TUI applications for tangible edges. Finally, in the Play Mode, the AR system 120 enables the user to test and experience the authored edge-based TUI applications.

A variety of methods, workflows, and processes are described below for enabling the operations and interactions of the Scan Mode, Author Mode, and Play Mode of the AR system 120. In these descriptions, statements that a method, workflow, processor, and/or system is performing some task or function refers to a controller or processor (e.g., the processor 125) executing programmed instructions (e.g., the tangible user interface authoring program 133, the AR graphics engine 134) stored in non-transitory computer readable storage media (e.g., the memory 126) operatively connected to the controller or processor to manipulate data or to operate one or more components in the TUI authoring system 100 to perform the task or function. Additionally, the steps of the methods may be performed in any feasible chronological order, regardless of the order shown in the figures or the order in which the steps are described.

Additionally, various AR graphical user interfaces are described for operating the AR system 120 in the Scan Mode, Author Mode, and Play Mode. In many cases, the AR graphical user interfaces include graphical elements that are superimposed onto the user's view of the outside world or, in the case of a non-transparent display screen 128, superimposed on real-time images/video captured by the camera 129. In order to provide these AR graphical user interfaces, the processor 125 executes instructions of the AR graphics engine 134 to render these graphical elements and operates the display 128 to superimpose the graphical elements onto the user's view of the outside world or onto the real-time images/video of the outside world. In many cases, the graphical elements are rendered at a position that depends upon position or orientation information received from any suitable combination of the sensors 130 and the camera 129, so as to simulate the presence of the graphical elements in the real-world environment. However, it will be appreciated by those of ordinary skill in the art that, in many cases, an equivalent non-AR graphical user interface can also be used to operate the tangible user interface authoring program 133, such as a user interface provided on a further computing device such as a laptop computer, a tablet computer, a desktop computer, or a smartphone.

Moreover, various user interactions with the AR graphical user interfaces and with interactive graphical elements thereof are described. In order to provide these user interactions, the processor 125 may render interactive graphical elements in the AR graphical user interface, receive user inputs from the user, for example via gestures performed in view of the one of the camera 129 or other sensor, and execute instructions of the tangible user interface authoring program 133 to perform some operation in response to the user inputs.

Finally, various forms of motion tracking are described in which spatial positions and motions of the user or of other objects in the environment are tracked. In order to provide this tracking of spatial positions and motions, the processor 125 executes instructions of the tangible user interface authoring program 133 to receive and process sensor data from any suitable combination of the sensors 130 and the camera 129, and may optionally utilize visual and/or visual-inertial odometry methods such as simultaneous localization and mapping (SLAM) techniques.

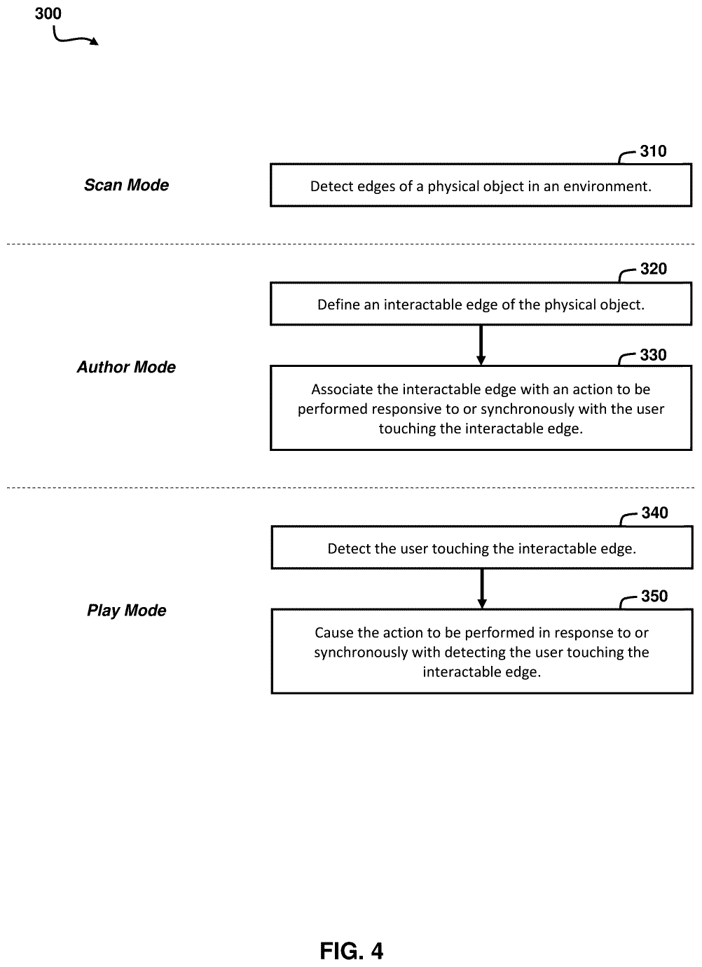

FIG. 4 shows a logical flow diagram for a method 300 for authoring AR applications having TUI interactions. The method 300 advantageously incorporates three primary software components. First, the method 300 leverages an edge detection pipeline for users to scan objects and register geometric edges. Second, the method 300 leverages the input-output model discussed above to efficiently prototype TUI applications. Third, the method 300 leverages an intuitive AR authoring interface that provides real-time visual feedback about what the user has authored.

In the Scan Mode, the method 300 begins with detecting edges of a physical object in an environment (block 310). Particularly, in the Scan Mode, the processor 125 operates at least one sensor, such as the RGB camera 129, the LIDAR camera 131, and/or sensors 130, to continuously measure sensor data of an environment of the user. The processor 125 detects, based on the sensor data, a plurality of object edges of one or more target physical objects in the environment. Moreover, based on the sensor data captured over time, the processor 125 tracks the plurality of object edges over time by matching object edges of the target physical object(s) detected over time with previously detected object edges of the target physical object(s).

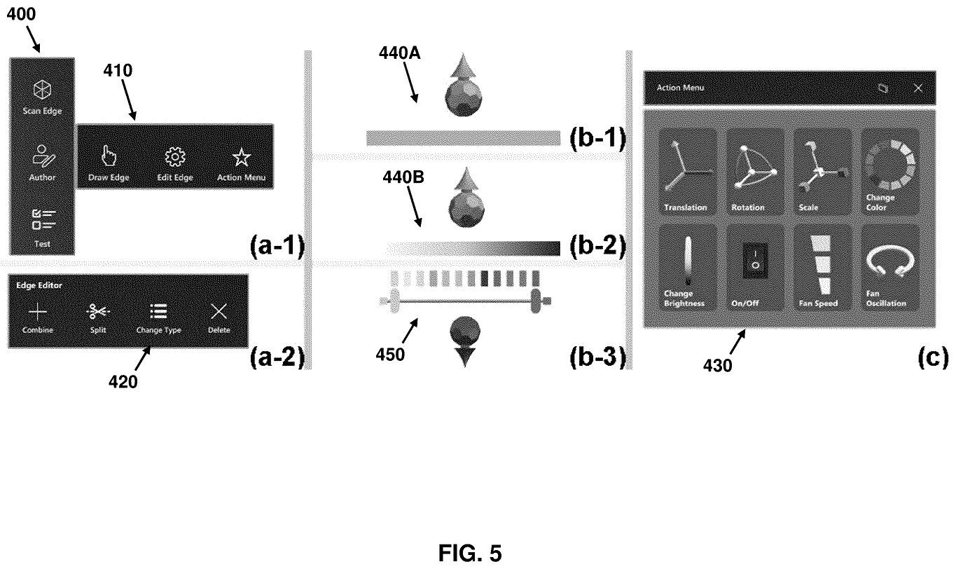

FIG. 5 shows interface elements of various AR graphical user interfaces of the TUI authoring system 100. Particularly, as shown in illustration (a-1), the AR graphical user interface includes an AR main menu 400. In some embodiments, the AR main menu floats next to a user's left hand during usage of the TUI authoring system 100. The left-hand column of buttons in the AR main menu 400 enables the user to switch between the different modes of the TUI authoring system 100, namely the Scan Mode, the Author Mode, and the Play Mode. The user can press each button of the AR main menu 400 to toggle on and off a respective sub-menu 410 for each mode, which take the form of a row of buttons that extend from the left-hand column. To enter the Scan Mode and begin the scanning process described below, the user presses the “Scan Edge” button of the AR main menu 400. Once in the Scan Mode, the AR system 120 begins registering and matching edges within the environment of the user, as discussed below.

The TUI authoring system 100 leverages an integrated algorithm for reconstructing, detecting, and tracking 3D edges on everyday objects as well as interactions between fingers and the 3D edges. Particularly, the TUI authoring system 100 provides ubiquitous and intuitive edge detection. In order for users to use any nearby geometric edges for TUIs, the TUI authoring system 100 is able to detect most edges around users and users' interactions with the edges accurately in real time.

To this end, in at least some embodiments, the AR system 120 adopts a vision-based pipeline for detecting and tracking edges of physical objects in the user's environment. In some embodiments, the vision-based pipeline includes four primary components. First, the vision-based pipeline includes a robust RGB-D point-cloud-based edge detection algorithm, which may for example be adapted from vanilla Canny Edge detector. The processor 125 executes the RGB-D edge detection algorithm to detect salient geometric edges in the environment, while suppressing image texture-based edges and redundant edges. Second, the vision-based pipeline includes a lightweight neural network object detector. The processor 125 executes the neural network object detector to separate the foreground from background, prune detected edges, and quickly eliminate large portions of background feature points, thereby saving computational effort. Third, the vision-based pipeline includes a pose estimation sub-system. The processor 125 executes the pose estimation sub-system to accurately track 6 degrees of freedom (DoF) of an object. Fourth, the vision-based pipeline includes an edge-based iterative closest point (ICP) algorithm. The processor 125 executes the edge-based ICP algorithm to refine and finalize the alignment and matched correspondence over time of object edges.

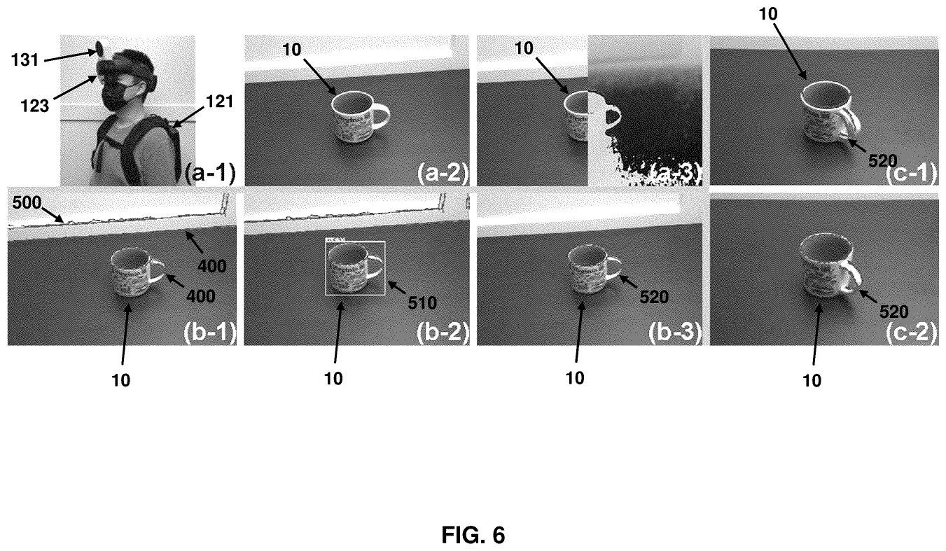

FIG. 6 illustrates the edge detection process that is performed in the Scan Mode by the TUI authoring system 100. In illustration (a-1), a user is shown wearing the AR-HMD 123 on his head and carrying the processing system 121 on his back. In the illustrated embodiment, the processing system 121 is in the form of a backpack computer. Additionally, in the illustrated embodiment, the AR-HMD 123 incorporates the high-precision LIDAR sensor 131 mounted on top of the AR-HMD 123, so that the AR system 120 is capable of detecting edges and touches. The AR system 120 as a whole is responsible for AR virtual content visualization, tracking objects and edges, and tracking hands and fingers of the user. Additionally, the AR-HMD 123 leverages SLAM techniques to obtain the global position of objects, edges, hands, and fingers in physical space. Illustration (a-2) shows an exemplary RGB camera view of the AR-HMD 123 including an RGB image of a coffee cup 10. Illustration (a-3) shows an RGB-D camera view of the AR-HMD 123, including the RGB image of the coffee cup 10 with depth information overlaid on the right.

To enable users to use any geometric edge in the surroundings, the processor 125 detects geometric edges through two steps: edge registration and edge matching. The edge registration is responsible for ascertaining geometric edge points of the object before authoring and edge matching is responsible for locating edges over time during both authoring and application use.

During the edge registration, based on RGB-D images including a target physical object, the processor 125 detects a plurality of edges of the environment including those of the target physical object. Particularly, the processor 125 executes the RGB-D edge detection algorithm of the vision-based pipeline to extract geometric edge points, i.e., high curvature edge points, where surface normals suddenly change. As shown in illustration (b-1) of FIG. 6, this initial edge detection automatically detects feature points for all geometric edges in the scene including edges of the coffee cup 10 and edges of the environment around the coffee cup 10. In some embodiments, the edge points 500 are overlaid upon the coffee cup 10 in the AR graphical user interface to visualize the edge detection process.

In some embodiments, the processor 125 identifies, using an object detection technique, a plurality of object edges of the object as a subset of the plurality of edges of the environment. Particularly, since edges on the target physical object are the more relevant concern, the processor 125 trims edges on the object out of the background. Specifically, the processor 125 executes the neural network object detector to obtain a bounding box 510 for the target physical object (e.g., the coffee cup 10), as shown in illustration (b-2) of FIG. 6. Next, the processor 125 projects the bounding box back to 3D using the depth information and removes the background edge points whose distance with the bounding box is beyond an empirical threshold of 2.5 cm and out of the bounding, as shown in illustration (b-3) of FIG. 6. Finally, the TUI authoring system 100 reconstructs the geometric outline of the object by merging all the extracted edge points captured from different viewpoints together. A post-processing filter is utilized for outlier removal. In this way, the processor 125 culls the detected edges to arrive at a subset of edge points 520 corresponding to edges of the target physical object (e.g., the coffee cup 10).

After edge registration, the processor 125 matches and tracks the object edges over time as the object is moved or perspective of the user changes. Particularly, whenever the target physical object is moved to a new position, the edge points' 6-DoFs change. Therefore, it is necessary to establish correspondence between original edge points and current edge points so that it can detect whether a user is interacting with an edge and decide which edge is being touched. To achieve this goal, the processor 125 performs edge matching. Specifically, the processor 125 detects the object in the same manner as it does during edge registration. Additionally, the processor 125 executes the pose estimation sub-system to track the 6-DoF pose of the target physical object. In one embodiment, the pose estimation sub-system adopts an off-the-shelf network-based keypoint detector and spatial-temporal non-local memory that is robust against hand occlusion. The processor 125 matches edges to previously detected edges based on changes over time in the tracked pose of the target physical object. However, the 6-DoF prediction result of the object may not exactly correspond to the pose of edges as there might be rotation errors or translation offsets, as shown in illustration (c-1) of FIG. 6. Therefore, the processor 125 executes the edge-based ICP algorithm to refine and finalize the alignment and matched correspondence over time of object edges, as shown in illustration (c-2) of FIG. 6. In this way, the processor 125 can match object edges of physical object(s) detected over time with previously detected object edges.

Returning to FIG. 4, in the Author Mode, the method 300 continues with defining an interactable edge of the physical object (block 320). Particularly, in the Author Mode, the processor 125 defines an interactable edge of a target physical object in an environment based on an interaction of a user with the physical object. It should be appreciated that, after the scanning process in the Scan Mode, the detected object edges and their descriptors so far are merely a set of 3D edge points without higher-order geometric structure. In other words, the TUI authoring system 100 has not defined which subsets of 3D points constitute a line segment that defines a particular interactable edge and has not estimated the parameters for describing the line segment. Thus, the edge points cannot be directly used to map digital functions. To this end, the TUI authoring system 100 lets users define a line segment corresponding to an interactable edge by touch.

Particularly, in at least some embodiments, to achieve intuitive edge selection/manipulation, the TUI authoring system 100 allows users to define interactable edges by demonstration by directly touching a tangible edge of a target physical object that is to be made into an interactable edge. The processor 125 detects, based on finger tracking data and edge detection data, a user touching an edge of the target physical object and defines at least part of the edge to be the interactable edge in response to the user touching the edge.

In some embodiments, the user simply taps a tangible edge of a target physical object to make the entire edge an interactable edge. Particularly, the processor 125 detects, based on finger tracking data and edge detection data, a user touching an edge of the physical object and defines at least part of the edge to be the interactable edge in response to the user touching the edge. Additionally, in some embodiments, the user slides his or her index finger along a tangible edge of a target physical object to select a portion of the tangible edge to be an interactable edge. Particularly, the processor 125 detects, based on finger tracking data and edge detection data, a user sliding a finger across the edge of the physical object and defines the interactable edge as a portion of the edge upon which the finger was slid. These finger touch-based interactions enable intuitive and precise manipulation on edges because the single finger interaction causes the least occlusion while providing intuitiveness.

Returning to FIG. 5, to enter the Author Mode and begin the TUI authoring process described below, the user presses the “Author” button of the AR main menu 400. Once in the Author Mode, the AR system 120 enables the user to begin defining interactable edges and associating them with actions to form TUI interactions, as discussed below. After pressing the “Author” button of the AR main menu 400, the submenu 410 for the Author Mode appears. The submenu 410 includes various options for authoring TUI interactions. To define an interactable edge, the user presses the “Draw Edge” button.

After user presses the “Draw Edge” button, the AR graphical user interface displays an AR visualization of the object edge points 520 corresponding to edges of the target physical object (e.g., the coffee cup 10), overlaid and aligned upon the target physical object. Now the user can select their desired interactable edge by sliding their index fingers along the tangible edge of the target physical object. The processor 125 determines a start and end point of the interactable edge based on the user sliding his or her finger from one point to another along the tangible edge. In one embodiment, the processor 125 starts/stops detecting the user's interaction with the tangible edge based on corresponding start and stop speech commands uttered by the user and captured using a microphone on the AR-HMD 123. The processor 125 defines a smooth line segment corresponding to the interactable edge using a line smoothing algorithm. After doing so, the processor 125 displays in the AR graphical user interface a visualization of the line segment to represent the defined interactable edge, as previously shown in illustration (b) of FIG. 1A. For each interactable edge defined by the user, the processor 125 stores in the memory 126 the inherent information including length, contained edge points, and path for later use.

With continued reference to FIG. 5, after defining one or more interactable edges, the user can press the “Edit Edge” button in the submenu 410 to open an edge editor menu 420, shown in illustration (a-2). Using the edge editor menu 420, the user can then combine interactable edges into a single interactable edge, split a single interactable edge into multiple interactable edges, change an interactable edge type of a particular interactable edge, and delete a particular interactable edge.

By pressing the “Change Type” button in the edge editor menu 420, the user can customize the edge type (e.g., discrete or continuous edges) which specifies the touch interaction type. Particularly, the processor 125 defines based on user inputs received from the user, an interactable edge type of each respective interactable edge. As discussed above, interactable edges may be either discrete edges or continuous edges. Edges that are of the discrete edge type cause an associated action to be performed depending on whether the user touches the interactable edge. In contrast, edges that are of the continuous edge type cause an associated action to be performed in a manner that depends on a location on the interactable edge of the physical object that is touched by the user.

Additionally, by pressing the “Split” button in the edge editor menu 420, the user can split a selected interactable edge into multiple interactable edges which share the same interactable edge type as the original interactable edge. Specifically, users can simply touch the current interactable edge and the interactable edge will be automatically segmented at the touch point.

Split interactable edges can also be merged back into their original form by pressing the “Combine” button in the edge editor menu 420. Additionally, to avoid the situation where users might mistakenly touch the nearby edge, the segmented edges are automatically separated by an empty interval with a predefined length of, for example, 1.1 cm. If a newly defined interactable edge overlaps with previously authored interactable edges, the processor 125 automatically segments the newly defined interactable edge at the point of intersection/overlap. Finally, by pressing the “Delete” button in the edge editor menu 420, the user can delete a previously defined interactable edge.

Returning to FIG. 4, in the Author Mode, the method 300 continues with associating the interactable edge with an action to be performed responsive to or synchronously with the user touching the interactable edge (block 330). Particularly, in the Author Mode, the processor 125 associates, based on user inputs received from the user, one of the previously defined interactable edges of a target physical object with an action to be performed in response to the user touching the associated interactable edge, thereby defining a TUI interaction. In at least one embodiment, the processor 125 selects an action to be associated with the interactable edge based on user inputs received from the user via the AR graphical user interface. Additionally, in some embodiments, the processor 125 records, based on sensor data received from the sensors 129, 130, 131, a demonstration by the user of the action to be performed and associates the recorded action with the interactable edge.

With reference again to FIG. 5, after the user finishes defining interactable edges, the user can specify the actions to be performed when the interactable edges are touched. Particularly, the user connects the interactable edge with an action through the trigger-action programming metaphor and, thereby, defines a TUI interaction. To this end, the user can press the “Action Menu” button of the submenu 410 to display various menus, including an action menu 430, for associating a one or more interactable edges with one or more actions of relevant virtual content or controllable physical devices (e.g., IoT smart devices). Illustration (c) of FIG. 5 shows the action menu 430, which contains all available action for relevant virtual content or controllable physical devices.

The previously defined interactable edges are visualized in the AR graphical user interface with corresponding interactable edge widgets 440A, 440B. Illustration (b-1) of FIG. 5 shows an interactable edge widget 440A, that includes a solid-colored line and connecting sphere to represent a discrete interactable edge. Illustration (b-2) of FIG. 5 shows an interactable edge widget 440B, that includes a gradient-colored line and connecting sphere to represent a continuous interactable edge.

As discussed above, output actions can be discrete actions or continuous actions. Discrete actions may include a discrete state change of a virtual object displayed in an AR graphical user interface or of a controllable physical device in the environment. In contrast, continuous actions may include a state change over time of a virtual object displayed in an AR graphical user interface or of a controllable physical device in the environment. To this end, the action menu 430 provides universal actions for AR virtual content (e.g., translations, rotations, scales, and animations), pre-defined actions based on the characteristics of AR virtual content, and pre-defined operations of controllable physical devices.

To associate an interactable edge with an action, the users drag an action from the action menu 430 into the AR scene. After dragging the action into the AR scene, an action customization widget 450 appears in the AR scene, as shown in (b-3) of FIG. 5. The user interacts with the action customization widget 450 to specify one or more parameters of the action to be performed. For example, users can decide whether the universal action change happens with respect to the users' coordinate or the global coordinate using a toggle button. As another example, for continuous actions, users need to specify the start and end values of the action between which the interactable edge will be mapped to. In some embodiments, the parameters of an action can be defined by recording a demonstration of the action. For example, the user may virtually manipulate a virtual object to define an animation action for the virtual object.

Finally, once the action has been customized as necessary, the user forms a TUI interaction by connecting a respective interactable edge with a respective action through a drag-and-drop interaction in the AR graphical user interface. Specifically, in the illustrated embodiments, the user pinches the connecting sphere of the interactable edge widget 440A, 440B for a respective interactable edge, drags a line out and releases the pinch on a connecting sphere of the action customization widget 450 of a respective action, thereby associating the interactable edge with the target action and defining a TUI interaction.

Returning to FIG. 4, in the Play Mode, the method 300 continues with detecting the user touching the interactable edge (block 340). Particularly, in the Play Mode, the processor 125 detects, based on finger tracking data and edge detection data, the user touching an interactable edge of a physical object that is part of a previously defined TUI interaction. With reference to FIG. 5, to enter the Play Mode and begin testing previously defined TUI interactions, the user presses the “Test” button of the AR main menu 400. Once in the Play Mode, the AR system 120 begins detecting whether the user touches interactable edges that are part of a previously defined TUI interaction. For a discrete interactable edge, the processor 125 detects whether the user has touched the interactable edge of the physical object. In contrast, for a continuous interactable edge, the processor 125 detects a particular location on the interactable edge of the physical object that is touched by the user.

In the Play Mode, the method 300 continues with causing the action to be performed in response to or synchronously with detecting the user touching the interactable edge (block 350). Particularly, in the Play Mode, the processor 125 causes an associated action to be performed in response to detecting the user touching an interactable edge of a physical object. In other words, once the touch interaction with an interactable edge is detected, any actions associated with that interactable edge will be triggered. In this way, in the Play Mode, the user can test and utilize any TUI interactions that they previously authored in the Author Mode. In some embodiments, in the Play Mode, the AR graphical user interface automatically hides all the lines and action icons previously displayed in the Author Mode, and only the interactable edges are visualized. Particularly, in one embodiment, the AR graphical user interface includes a visualization, such as highlighting, that is superimposed upon the interactable edge of the physical object to indicate to the user that the particular tangible edge of the object is interactive.

The action associated with an interactable edge may include a state change or operation of relevant virtual content. In the case of virtual content, causing the action to be performed includes rendering, with the processor 125, and displaying, on the display screen 128, in the AR graphical user interface, a state change or operation of the virtual content. In the case of a discrete output action, such a state change of virtual content may include, for example, a discrete and immediate change in position, color, shape, pose, or similar. In the case of a continuous output action, such a state change of virtual content may include, for example, a change over time in position, color, shape, pose, or similar (i.e. an animation).

The action associated with an interactable edge may include a state change or operation of a controllable physical device. In the case of controllable physical devices, causing the action to be performed includes the processor 125 operating a transceiver (e.g., the Wi-Fi module 127) to transmit a command message to the controllable physical device that is configured to cause the controllable physical device to perform the state change or operation. In the case of a discrete output action, such a state change of a controllable physical device may include, for example, a discrete and immediate change in power state, operating mode, or similar. In the case of a continuous output action, such a state change of a controllable physical device may include, for example, a motion of some part of the controllable physical device, a movement of the controllable physical device through the environment, an operation performed on a workpiece, a gradual change in state over time, or similar

For a discrete output action, the processor 125 causes a discrete state change of relevant virtual content or controllable physical devices in the environment. If the discrete output action was triggered by a discrete interactable edge (i.e., in the case of a Discrete-Discrete TUI), then the action occurs in response to the user touching the interactable edge but in a manner that does not depend on the particular location on the interactable edge that was touched. However, if the discrete output action was triggered by a continuous interactable edge (i.e., in the case of a Continuous-Discrete TUI), then the action occurs in response to the user touching the interactable edge and in a manner that depends on the particular location on the interactable edge that was touched.

In contrast, for a continuous output action, the processor 125 causes a state change over time of relevant virtual content or controllable physical devices in the environment. If the continuous output action was triggered by a discrete interactable edge (i.e., in the case of a Discrete-Continuous TUI), then the action occurs in response to the user touching the interactable edge but in a manner that does not depend on the particular location on the interactable edge that was touched. However, if the continuous output action was triggered by a continuous interactable edge (i.e., in the case of a Continuous-Continuous TUI), then the action occurs synchronously with the user touching the interactable edge and in a manner that depends on the particular location over time on the interactable edge that is touched.

### Exemplary Use Cases

With the TUI authoring system 100, end-users are allowed to utilize the edges on nearby everyday objects to control virtual contents in an AR graphical user interface, as well as controllable physical devices (e.g., IoT devices). Four different exemplary TUI applications are discussed below that can be authored using the TUI authoring system 100.

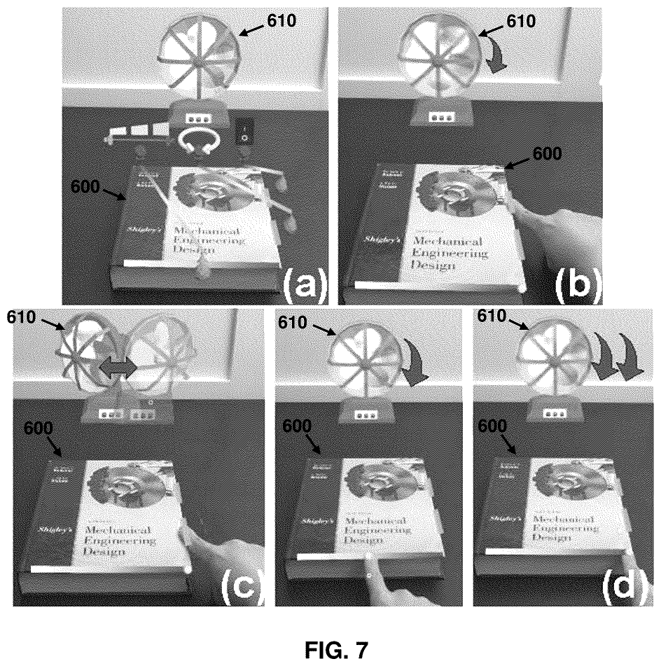

FIG. 7 shows a first exemplary TUI application in which an object is repurposed into a multi-functional controller. Multi-functional controllers have been widely used for AR content manipulation due to the complexity of virtual contents. With the support of the TUI authoring system 100, users can instantly repurpose a daily object into a multi-functional controller by choosing multiple edges on the object and connecting selected edges with different output actions respectively. As shown in illustration (a) of FIG. 7, a user connects the ‘upper right’ discrete interactable edge of a book 600 with an ‘on/off’ action of a virtual fan 610, the ‘lower right’ discrete interactable edge of the book 600 with an ‘oscillating’ action of the virtual fan 610, and the ‘bottom’ continuous interactable edge with a ‘fan speed’ action of the virtual fan 610. In illustration (b) of FIG. 7, the user touches the ‘upper right’ interactable edge, which causes the virtual fan 610 to start or stop. In illustration (c) of FIG. 7, the user touches the ‘lower right’ interactable edge, which causes the virtual fan 610 to oscillate. Finally, in illustration (d) of FIG. 7, the user slides his or her finger on the ‘bottom’ interactable edge of the book 600, which causes the virtual fan 610 to change speed.

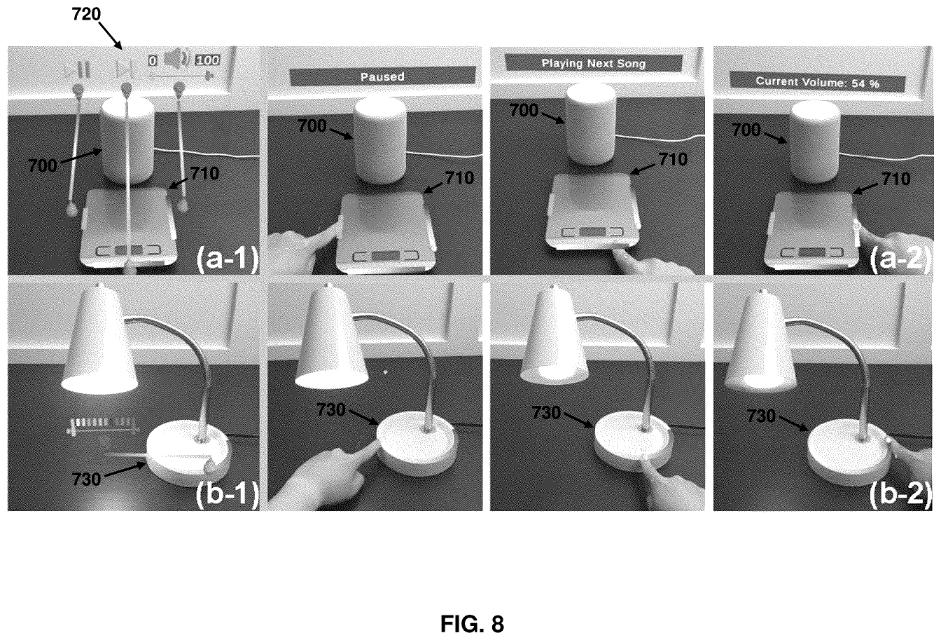

FIG. 8 shows a second exemplary TUI application in which ubiquitous control is enabled over physical smart objects. Recently, nascent and consumer-oriented IoT devices (e.g., smart light bulbs, thermostats, and speakers) which integrate physical objects with digital sensors, are rapidly increasing in people's working and living environments. Currently, the most common way to control IoT devices is to use a smartphone. However, the TUI authoring system 100 empowers users to utilize the nearby edges to manipulate IoT functions. As shown in illustration (a-1) of FIG. 8, a user controls a smart speaker 700 using edges of a digital scale 710 at his or her desk. The user maps the three interactable edge segments (i.e., ‘left’ discrete interactable edge, ‘bottom’ continuous interactable edge, ‘right’ continuous interactable edge) of the digital scale with functions of a virtual audio player 720 associated with the physical smart speaker 700. Particularly, the ‘left’ discrete interactable edge of the digital scale 710 is connected to a ‘pause/play’ action of the virtual audio player 720, the ‘bottom’ continuous interactable edge of the digital scale is connected to ‘next/previous’ action of the virtual audio player 720, and the ‘right’ continuous interactable edge of the digital scale is connected to a ‘volume’ action of the virtual audio player 720. As shown in illustration (a-2) of FIG. 8, the user can touch the scale's ‘left’ interactable edge to start playing or pause music on the smart speaker 700. The user can swipe right on the ‘bottom’ interactable edge to change to the next track. Finally, the user can swipe down along the ‘right’ interactable edge to lower the volume of the music. Illustration (b-1) of FIG. 8 shows a similar example in which a user controls a color of a smart light bulb of a lamp 730 using the continuous interactable edge on a base of the lamp 730. As shown in illustration (b-2) of FIG. 8, the user can change the color of the light bulb by moving his or her finger from the left of the interactable edge to the middle, and to the right.

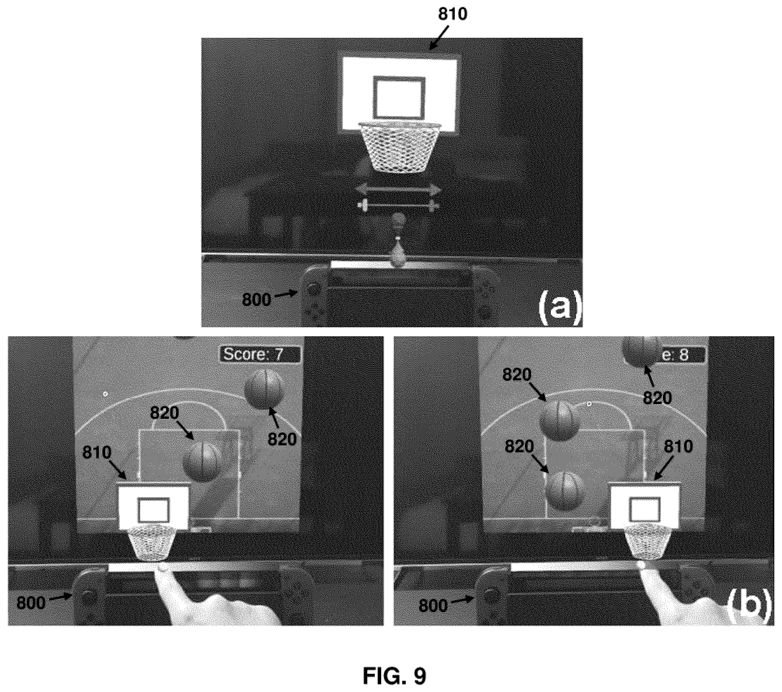

FIG. 9 shows a third exemplary TUI application in which an interactive tangible AR game is authored. Besides utilizing ambient edges to improve the quality of life, users are also able to create AR game controllers for entertainment with the support of the TUI authoring system 100. As shown in FIG. 9, the user utilizes a top edge of a handheld game console 800 to control a virtual basketball hoop 810 in the horizontal direction so that the basketball hoop 810 can catch falling basketballs 820. As shown in illustration (a) of FIG. 9, the user connects the ‘upper’ interactable edge of the handheld game console 800 with a ‘horizontal translation’ action of the virtual basketball hoop 810. In illustration (b) of FIG. 9, the user slides his or her finger in the right direction to cause the virtual basketball hoop 810 to correspondingly move in the same direction, to catch falling basketballs 820 in the virtual basketball hoop 810.

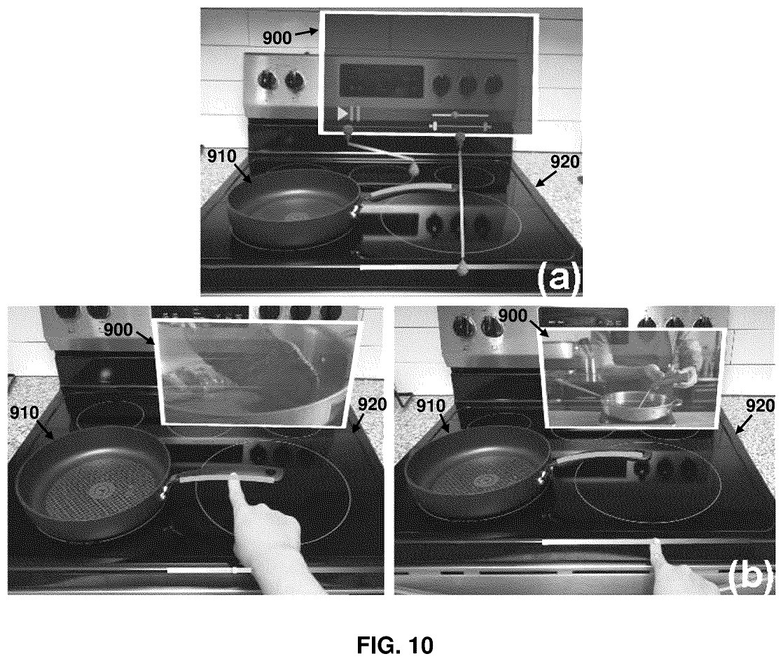

FIG. 10 shows a fourth exemplary TUI application in which a ubiquitous tangible AR tutorial is authored. The TUI authoring system 100 can also facilitate task performance for users. For example, users can author a tutorial-based TUI by attaching a video display action to an edge of a frying pan for cooking study. As shown in illustration (a) of FIG. 10, the user attaches a ‘play/pause’ function of a virtual video player 900 to a discrete interactable edge on a handle of a frying pan 910, and a ‘playing progress’ function of the virtual video player 900 to a continuous interactable edge of an electric stove top 920. As shown in illustration (b) of FIG. 10, the user can then start watching a cooking video when his or her finger touches the interactable edge on the handle of the frying pan 910 and can jump to his or her favorite parts of the video by sliding his or her finger on the interactable edge of the electric stove top 920.

Embodiments within the scope of the disclosure may also include non-transitory computer-readable storage media or machine-readable medium for carrying or having computer-executable instructions (also referred to as program instructions) or data structures stored thereon. Such non-transitory computer-readable storage media or machine-readable medium may be any available media that can be accessed by a general purpose or special purpose computer. By way of example, and not limitation, such non-transitory computer-readable storage media or machine-readable medium can comprise RAM, ROM, EEPROM, CD-ROM or other optical disk storage, magnetic disk storage or other magnetic storage devices, or any other medium which can be used to carry or store desired program code means in the form of computer-executable instructions or data structures. Combinations of the above should also be included within the scope of the non-transitory computer-readable storage media or machine-readable medium.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

While the disclosure has been illustrated and described in detail in the drawings and foregoing description, the same should be considered as illustrative and not restrictive in character. It is understood that only the preferred embodiments have been presented and that all changes, modifications and further applications that come within the spirit of the disclosure are desired to be protected.

What is claimed is:

1. A method for authoring an application incorporating a tangible user interface, the method comprising:
defining, with a processor, an interactable edge of a physical object in an environment based on a physical interaction of a user with the physical object;
associating, with the processor, based on user inputs received from the user, the interactable edge of the physical object with an action to be performed in response to the user touching the interactable edge of the physical object; and
causing, with the processor, the action to be performed in response to detecting the user touching the interactable edge of the physical object.

2. The method according to claim 1 further comprising:
detecting, with the processor, a plurality of edges of the physical object in the environment, the interactable edge being at least part of one of the plurality of edges; and
tracking, with the processor, the plurality of edges over time by matching edges of the physical object detected over time with previously detected edges of the physical object.

3. The method according to claim 2, the detecting the plurality of edges of the physical object further comprising:
detecting, with the processor, a plurality of edges of the environment including the physical object; and
identifying, with the processor, using an object detection technique, the plurality of edges of the object as a subset of the plurality of edges of the environment.

4. The method according to claim 2, the tracking the plurality of edges over time further comprising:
tracking, with the processor, a pose of the object over time; and
matching edges of the physical object detected over time with previously detected edges of the physical object, based on changes in the pose of the object over time.

5. The method according to claim 1, the defining the interactable edge of the physical object further comprising:
detecting, with at least one sensor, a user touching an edge of the physical object; and
defining, with the processor, at least part of the edge to be the interactable edge in response to the user touching the edge.

6. The method according to claim 5, the defining the interactable edge of the physical object further comprising:
detecting, with at least one sensor, a user sliding a finger across the edge of the physical object; and
defining, with the processor, the interactable edge as a portion of the edge upon which the finger was slid.

7. The method according to claim 1, the defining the interactable edge of the physical object further comprising:
defining, with the processor, based on user inputs received from the user, an interactable edge type of the interactable edge, the interactable edge type being one of:
a first interactable edge type that causes the action to be performed depending on whether the user touches the interactable edge of the physical object; and
a second interactable edge type that causes the action to be performed in a manner that depends on a location on the interactable edge of the physical object that is touched by the user.

8. The method according to claim 1, the associating the interactable edge with the action further comprising:
displaying, on a display of an augmented reality device, an augmented reality graphical user interface; and
selecting, with the processor, the action to be performed based on user inputs received from the user via the augmented reality graphical user interface.

9. The method according to claim 1, the associating the interactable edge with the action further comprising:
recording, with the processor, a demonstration by the user of the action to be performed.

10. The method according to claim 1, the causing the action to be performed further comprising:
detecting, with the processor, whether the user has touched the interactable edge of the physical object; and
causing, with the processor, a discrete state change of at least one of (i) a virtual object displayed in an augmented reality graphical user interface of an augmented reality device and (ii) a controllable physical device in the environment, the discrete state change being the action associated with the interactable edge.

11. The method according to claim 1, the causing the action to be performed further comprising:
detecting, with the processor, whether the user has touched the interactable edge of the physical object; and
causing, with the processor, a state change over time of at least one of (i) a virtual object displayed in an augmented reality graphical user interface of an augmented reality device and (ii) a controllable physical device in the environment, the change over time being the action associated with the interactable edge.

12. The method according to claim 1, the causing the action to be performed further comprising:
detecting, with the processor, a location on the interactable edge of the physical object that is touched by the user; and
causing, with the processor, a discrete state change of at least one of (i) a virtual object displayed in an augmented reality graphical user interface of an augmented reality device and (ii) a controllable physical device in the environment, the discrete state change being the action associated with the interactable edge, the discrete state change depending on the location on the interactable edge of the physical object that is touched by the user.

13. The method according to claim 1, the causing the action to be performed further comprising:
detecting, with the processor, a location over time on the interactable edge of the physical object that is touched by the user; and
causing, with the processor, a state change over time of at least one of (i) a virtual object displayed in an augmented reality graphical user interface of an augmented reality device and (ii) a controllable physical device in the environment, the state change over time being the action associated with the interactable edge, the state change over time depending on the location over time on the interactable edge of the physical object that is touched by the user.

14. The method according to claim 1, wherein the action includes one of (i) a change of status and (ii) a change over time of a virtual object displayed in an augmented reality graphical user interface of an augmented reality device, the causing the action to be performed further comprising:
displaying, in the augmented reality graphical user interface, the one of (i) the discrete state change and (ii) the state change over time of the virtual object.

15. The method according to claim 14, where in the discrete state change of the virtual object is an immediate change in at least one of a position, a color, a shape, and a pose of the virtual object.

16. The method according to claim 14, wherein the state change over time of the virtual object is an animation of the virtual object over time.

17. The method according to claim 1, wherein the action includes one of (i) a change of state and (ii) a change over time of a controllable physical device in the environment, the causing the at least one action to be performed further comprising:
transmitting, with a transceiver, a command message configured to cause the controllable physical device to perform the one of (i) the discrete state change and (ii) the state change over time.

18. The method according to claim 17, wherein the discrete state change of the controllable physical device is an immediate change in at least one of a power state and an operating mode of the controllable physical device.

19. The method according to claim 17, wherein the state change over time is a motion of the controllable physical device over time.

20. The method according to claim 1, the associating the interactable edge with the action further comprising:
displaying, on a display of an augmented reality device, an augmented reality graphical user interface, the augmented reality graphical user interface including highlighting superimposed upon the interactable edge of the physical object.
